(19) United States
(12) Patent Application Publication
(10) Pub. No.: US 2018/0034763 A1
(43) Pub. Date: Feb. 1, 2018

(54) METHODS AND SYSTEMS TO PRIORITIZE, MANAGE, AND ARCHIVE CHAT CONVERSATIONS

(71) Applicant: International Business Machines Corporation, Armonk, NY (US)

(72) Inventors: Orlando E. Rincon Ferrera, Tlaquepaque (MX); Agueda Martinez Hernandez Magro, Zapopan (MX); Alina D. Marin Rodriguez, Tepic (MX); Adalberto Lopez Venegas, Tepic (MX)

(21) Appl. No.: 15/223,298

(22) Filed: Jul. 29, 2016

(51) Int. Cl. H04L 12/58

(52) U.S. Cl. CPC H04L 51/26; H04L 51/16; H04L 51/043; H04W 4/14

(57) ABSTRACT

A computer-implemented method for prioritizing a chat conversation of a plurality of chat conversations is claimed. An identity of a chat recipient of the chat conversation is determined. An initial window priority is established based on the identity of the chat recipient. Chat conversation data is received from the chat recipient. A semantic analysis is performed on the chat conversation data. The priority is recalculated based on the semantic analysis, where the semantic analysis includes identification of user-defined keywords. A priority indication is rendered for the plurality of chat conversations based on the adjusted priority. The chat conversation is closed after a predetermined duration from detection of a signoff phrase, in combination with a predetermined duration of inactivity. The chat conversation is saved or deleted based on the recalculated priority.

### FIELD OF THE INVENTION

Embodiments of the present invention relate generally to methods and systems to prioritize, manage, and archive chat conversations.

### BACKGROUND

Today, people get involved in a multitude of electronic conversations with different people. Instant messaging, short message service (SMS) messaging, and other types of electronic messaging allow people to hold numerous conversations in tandem or at once. The number of conversations in which a person participates can become very high. That number, as well as the number of contacts and variety of topics of conversations, can make management of such conversations challenging. There exists a need to ease the difficulty in such management.

### SUMMARY

A computer-implemented method for prioritizing a chat conversation of a plurality of chat conversations is claimed. An identity of a chat recipient of the chat conversation is determined. An initial window priority is established based on the identity of the chat recipient. Chat conversation data is received from the chat recipient. A semantic analysis is performed on the chat conversation data. The priority is recalculated based on the semantic analysis, where the semantic analysis includes identification of user-defined keywords. A priority indication is rendered for the plurality of chat conversations based on the adjusted priority. The chat conversation is closed after a predetermined duration from detection of a signoff phrase, in combination with a predetermined duration of inactivity. The chat conversation is saved or deleted based on the adjusted (i.e. recalculated) priority.

In one embodiment, there is provided a computer-implemented method for prioritizing a chat conversation of a plurality of chat conversations, the method comprising: determining an identity of a chat recipient of the chat conversation; establishing an initial chat conversation priority based on the identity of the chat recipient; receiving chat conversation data from the chat recipient; performing a semantic analysis on the chat conversation data; recalculating the chat conversation priority based on the semantic analysis, wherein the steps of receiving chat conversation data, performing a semantic analysis on the chat conversation data, and recalculating the chat conversation priority are repeated during the lifetime of the chat conversation, wherein the semantic analysis includes identification of user-defined keywords; and rendering a priority indication for the plurality of chat conversations based on the adjusted chat conversation priority.

In another embodiment, there is provided a device comprising: a processor; a memory coupled to the processor; an electronic display coupled to the processor; wherein the memory contains instructions, which when executed by the processor, perform the steps of: determining an identity of a chat recipient of the chat conversation; establishing an initial chat conversation priority based on the identity of the chat recipient; receiving chat conversation data from the chat recipient; performing a semantic analysis on the chat conversation data; recalculating the chat conversation priority based on the semantic analysis, wherein the semantic analysis includes identification of user-defined keywords; rendering on the electronic display, a priority indication for the plurality of chat conversations based on the adjusted chat conversation priority.

In yet another embodiment, there is provided a computer program product for prioritizing a chat conversation on an electronic device, comprising a computer readable storage medium having program instructions embodied therewith, the program instructions executable by a processor to cause the electronic device to: render an identity of a chat recipient of the chat conversation; establish an initial chat conversation priority based on the identity of the chat recipient; obtain chat conversation data from the chat recipient; perform a semantic analysis on the chat conversation data; recalculate the chat conversation priority based on the semantic analysis, wherein the semantic analysis includes identification of user-defined keywords; and render a priority indication for the plurality of chat conversations based on the adjusted chat conversation priority.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is a block diagram of a device in accordance with embodiments of the present invention.

FIG. 2 is a block diagram of software modules within an application in accordance with embodiments of the present invention.

FIGS. 3A-3C are example data tables in accordance with embodiments of the present invention.

FIG. 4A shows exemplary chat conversations.

FIG. 4B shows exemplary chat conversations with signoff phrases.

FIG. 5 shows an embodiment including user-added keywords.

FIG. 6 shows examples of rendering priority indications.

FIG. 7 is a flowchart indicating process steps for embodiments of the present invention.

FIG. 8 shows a client-server system in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

A computer-implemented method for prioritizing a chat conversation of a plurality of chat conversations is claimed. An identity of a chat recipient of the chat conversation is determined. An initial window priority is established based on the identity of the chat recipient. Chat conversation data is received from the chat recipient. A semantic analysis is performed on the chat conversation data. The priority is recalculated based on the semantic analysis, where the semantic analysis includes identification of user-defined keywords. A priority indication is rendered for the plurality of chat conversations based on the adjusted priority. The chat conversation is closed after a predetermined duration from detection of a signoff phrase, in combination with a predetermined duration of inactivity. The chat conversation is saved or deleted based on the adjusted (i.e. recalculated) recalculated priority.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

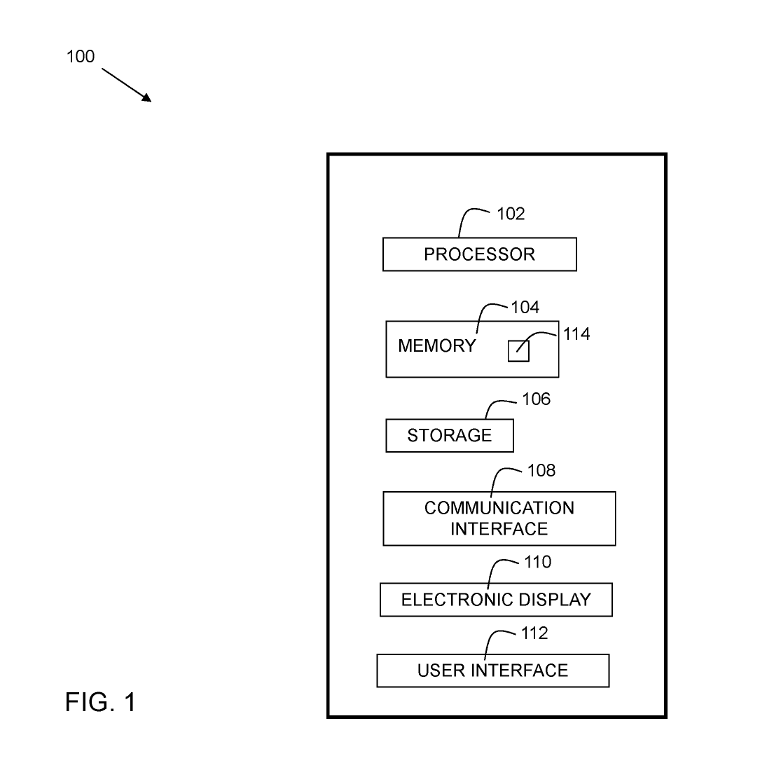

FIG. 1 is a block diagram of an electronic device 100 in accordance with embodiments of the present invention. Device 100 includes a processor 102. The processor 102 may include one or more processing cores. Device 100 further includes memory 104. The memory 104 is coupled to the processor such that instructions stored in memory 104 can be executed by the processor 102 to implement aspects of disclosed embodiments. The memory 104 may include dynamic random access memory (DRAM), static random access memory (SRAM), magnetic storage, and/or a read only memory such as flash, EEPROM, optical storage, or other suitable memory. In some embodiments, the memory 104 may not be a transitory signal per se. Device 100 may further include additional storage 106. Additional storage 106 may include, but is not limited to, solid state storage such as SRAM, Flash, and/or magnetic or optical storage. Device 100 further includes a communication interface 108. The communication interface 108 may support a variety of protocols, including, but not limited to, WiFi, Bluetooth™, Ethernet, TCP/IP, UDP, and/or other protocols and/or standards for communication. Device 100 further includes an electronic display 110. The electronic display may include a liquid crystal display (LCD), a plasma display, a cathode ray tube (CRT) display, a light emitting diode (LED) display, an organic LED (OLED) display, or other suitable display technology. Device 100 further includes a user interface 112. In some embodiments, user interface 112 may be a touch screen, and in some embodiments, may include a capacitive and/or resistive touch screen. The user interface may provide a mechanism for a user to enter text or other content into an application such as an email program, text messaging program, and/or web browser.

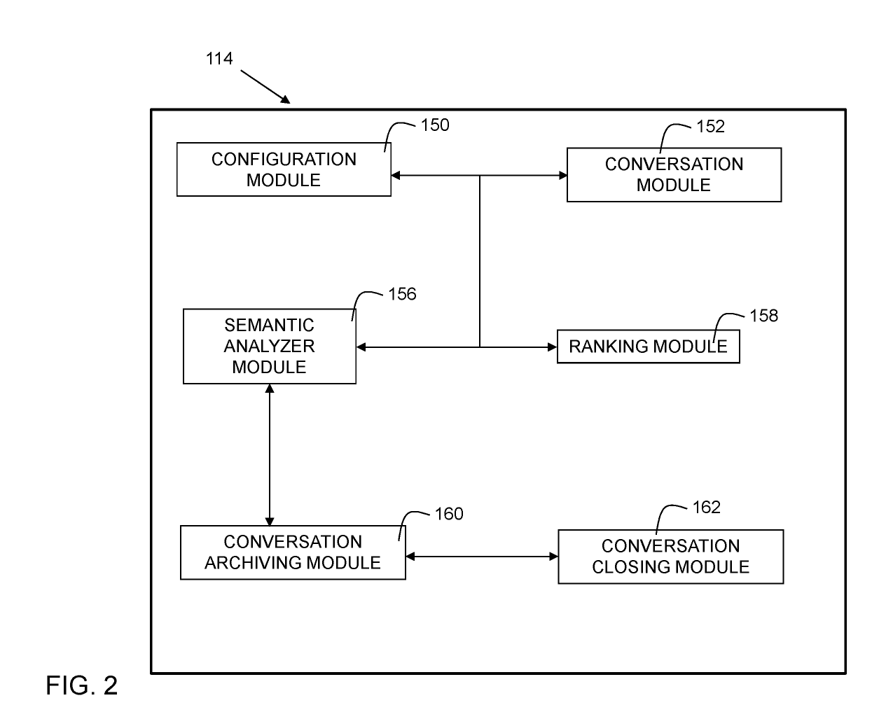

Referring again to memory 104, one or more software modules configured to perform tasks and/or instructions for carrying out embodiments of the present invention may be stored therein, represented at 114. Additional details of the application 114 are shown in FIG. 2. In some embodiments, such modules or instructions may be located on a user device or on a server in communication with the user device over a network.

FIG. 2 is a block diagram of software modules in accordance with embodiments of the present invention. Modules of the application are in communication with one another as shown in FIG. 2. Configuration module 150 allows a user to set preferences. Setting of preferences may include, without limitation, indicating relative priority of contacts, setting of a time period for closing of a chat window, identifying of keywords, etc. Conversation module 152 provides chat functionality. As is known, a user of a device may send to, and receive from, another user's device (“chat recipient”): messages having content including, without limitation, text, voice, photo, video, etc. The conversation created is typically shown in a window on a screen of the user's device. Semantic analyzer module 156 searches the conversations in chat windows for keywords. Ranking module 158 ranks open chat windows based on criteria. The criteria may include, without limitation, the identity (i.e., name) of the person with whom the user is chatting (i.e., the recipient of the conversation). Conversation archiving module 160 archives conversations. In some embodiments, the chat conversation is saved/archived if the chat conversation is deemed as a high priority chat conversation. In some embodiments, the chat conversation is automatically deleted after a user-initiated closing of the chat conversation if the chat conversation is calculated/deemed as a low priority chat conversation. Conversation closing module closes chat windows. In some embodiments, the closing may occur in response to dormancy of a window for a predetermined duration of time following a detection of a “signoff” phrase (e.g., “goodbye”, “bye”, “TTYL”, etc.).

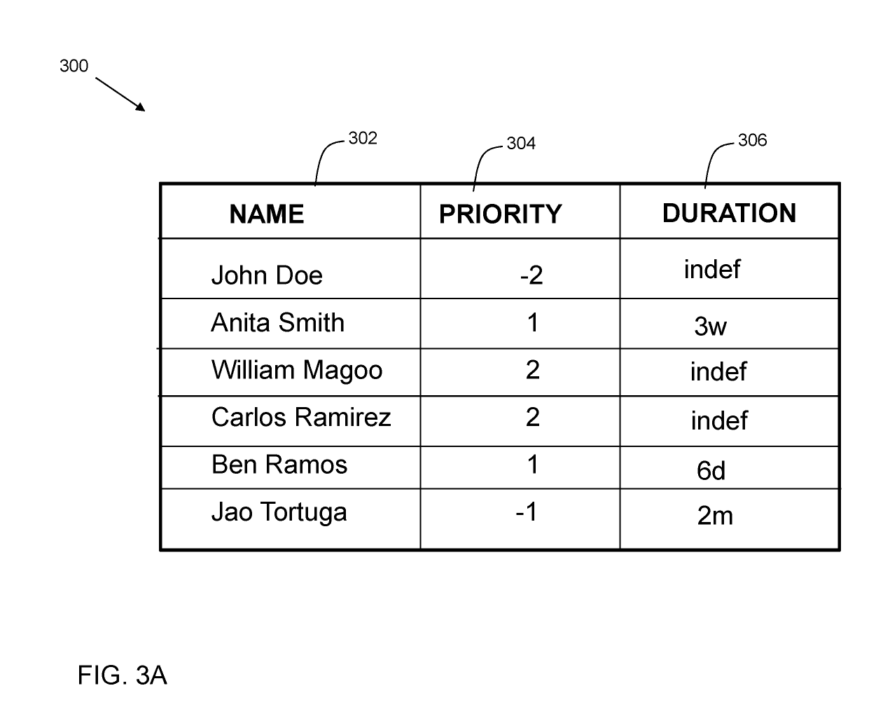

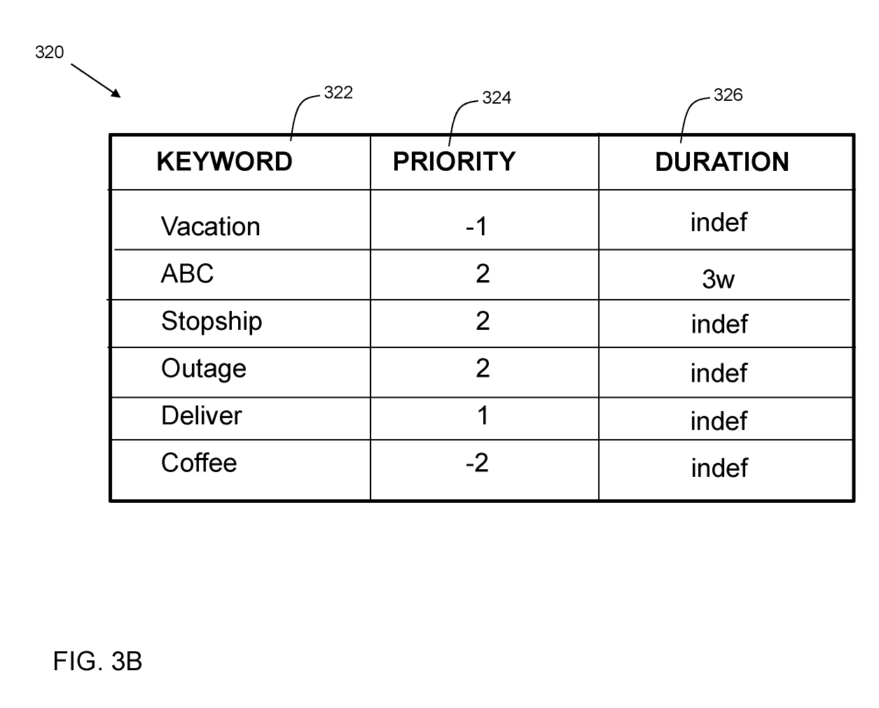

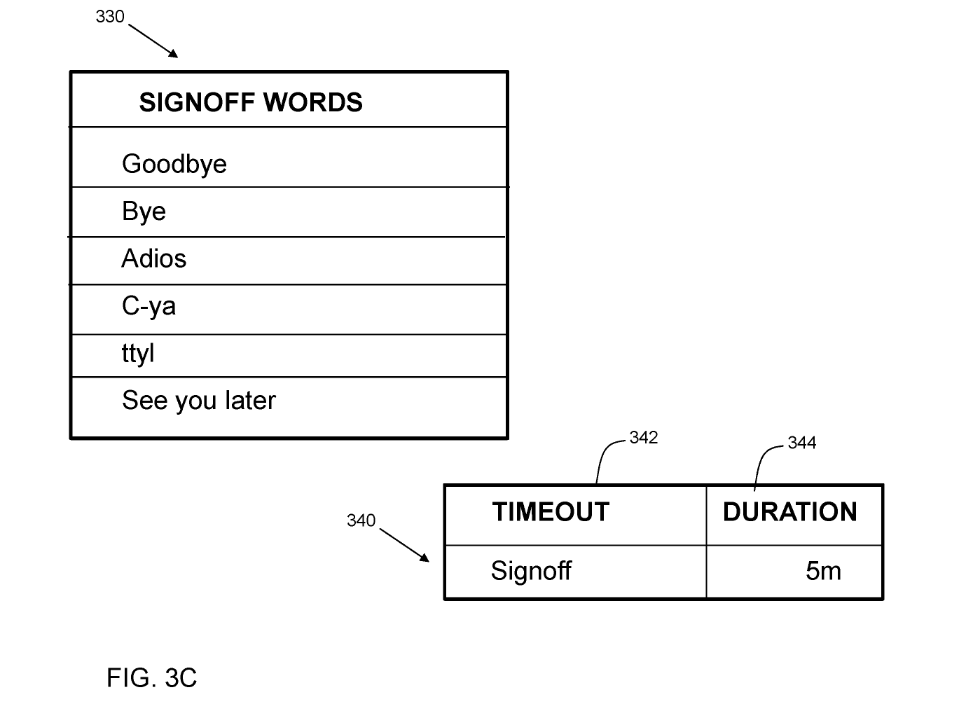

FIGS. 3A-3C are data tables in accordance with embodiments of the present invention. FIG. 3A shows table 300 having three columns. Column 302 shows contact identifier (i.e., name). Column 304 shows priority associated with the contact listed in the same respective row. Column 306 shows the time period in which the contact's priority expires (for example, without limitation, in seconds, minutes, hours, days, weeks, years, indefinitely, etc.). In the example shown, priority is designated by a positive or negative numeral, or a zero (0). Zero is neutral, positive numerals are higher priority than neutral, and negative numerals are lower priority than neutral. The greater the absolute value of the numeral, the higher or lower the priority depending on whether the numeral is positive or negative, respectively. Note that in embodiments, other methods of labeling priority may be implemented, and any of such methods are included within the scope of the invention.

In embodiments, a list of chat contacts is established. An initial chat conversation priority for each chat contact is established in the list of chat contacts. It may be established by, for example, without limitation, user designation when entering the contact to the contact list in his/her device. For example, the user may enter the contact identifier, priority, and duration of the priority into fields of a user interface. Priority may otherwise be established, or later recalculated, based on further information, for example, a geolocation of the chat recipient. For example, contacts which are geographically closer (e.g., within a particular radius) to the user may be prioritized more highly than contacts which are further away (e.g., outside of the particular radius). This may indicate that such closer contacts are at the same conference as the user is currently attending at a location remote from a main office. The distance between the user and the chat recipient may be determined using a global positioning system.

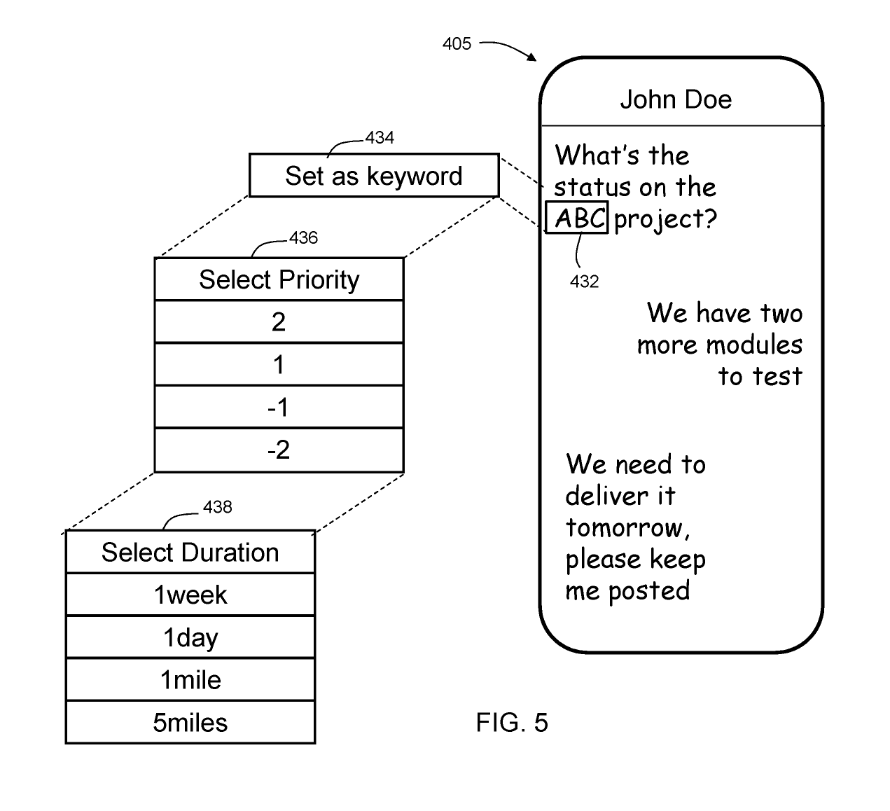

FIG. 3B shows table 320 having three columns. Column 322 shows a keyword. Column 324 shows priority associated with the keyword listed in the same respective row. Column 326 shows the time period in which the keyword's priority expires (e.g., indefinitely (“indef”), 3 weeks (“3w”), etc.). See FIG. 5.

FIG. 3C shows tables 330 and 340. Table 330 shows a listing of words, which are designated as “signoff words”. Table 340 shows column 342 having methods of timeout, and column 344 having durations associated with the respective methods. In the example shown, a chat window will be closed after five minutes passing following detection of a signoff word in a chat window (as identified from table 340).

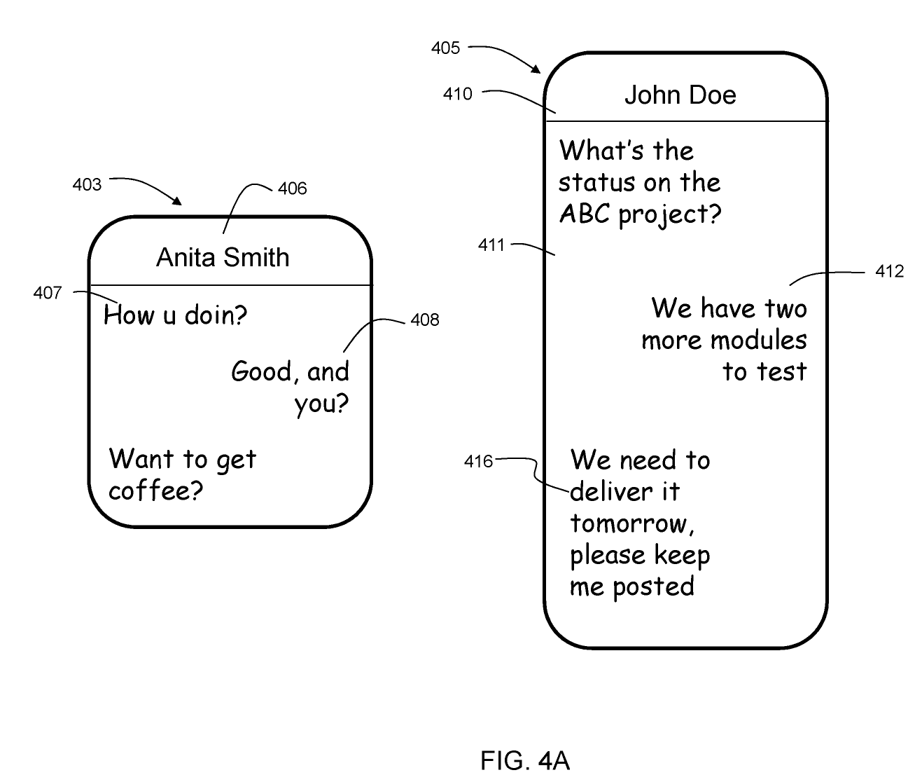

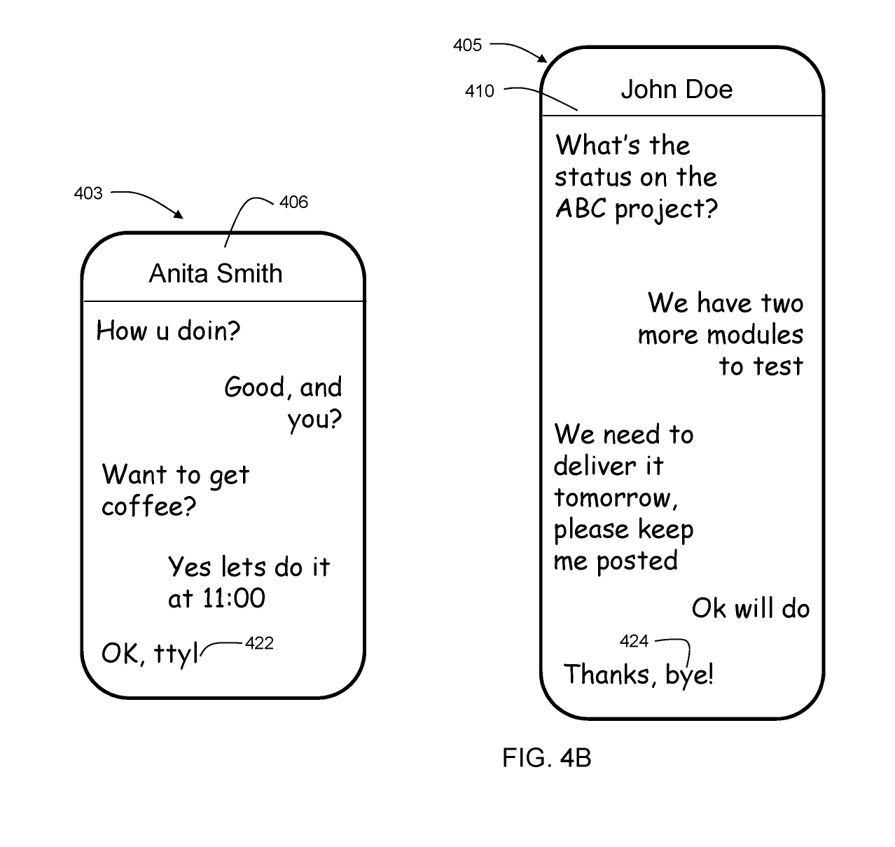

FIG. 4A shows exemplary chat conversations. At 403, there is a diagram of a user interface of a device, for example, without limitation, of a mobile phone or tablet computer. At 406, there is shown the contact identifier of the chat recipient (i.e. name) with whom the user of the device rendering interface 403 is communicating. The left side 407 of the interface shows communications outgoing from the device (entered from the user of the device), and the right side 408 shows incoming communications (received from a device of a chat recipient).

At 405, there is a diagram of a user interface of a device, for example, without limitation, a mobile phone or tablet computer. At 410, there is shown the contact identifier of the chat recipient (i.e. name) with whom the user of the device rendering interface 405 is communicating. The left side 411 of the interface shows communications outgoing from the device, and the right side 412 shows incoming communications. Keyword 416 is indicated in the chat conversation shown in 405. Keyword 416 indicates the word “deliver” which, in the example data from table 320 of FIG. 3B, is listed as a keyword with a positive priority value. Hence, the presence of the word “deliver” in the chat conversation in 405 raises the priority of that conversation.

It should be recognized that the user interfaces of FIG. 4A are examples. In embodiments, the interfaces may be configured differently, or include more or fewer features.

FIG. 4B shows exemplary chat conversations with signoff phrases. Interface 403 is expanded to show further communications. At 422, there is shown an example signoff phrase. In response to the system detecting the signoff phrase, the chat conversation is closed after a predetermined duration from the detection of the signoff phrase. For example, the signoff phrase “ttyl” is detected in interface 403, and the conversation is then closed five minutes later. See FIG. 3C for the database tables including “ttyl” as a signoff phrase and five minutes as the duration for closing after detection of such a phrase. Similarly, interface 405 is expanded to show further communications. At 424, there is shown another example signoff phrase (“bye”). In response to the system detecting the signoff phrase, the chat conversation is closed after a predetermined duration from the time of detection of the signoff phrase.

FIG. 5 shows an embodiment including user-added keywords. In embodiments, a list of keywords is established, and a priority is established for each keyword in the list of keywords. As shown on user interface 405, a keyword “ABC” is set. In the example, the user right-clicks (or otherwise selects) “ABC” 432. As represented at 434, in response to the right-click, a pop-up window appears, from which user selects an option to set as a keyword. As represented at 436, the user is prompted to set a priority of the keyword from a pop-up window. The user clicks the desired priority, and the information is saved in memory. As represented at 438, the user is prompted to set a duration for the priority of the keyword from another pop-up window. The user clicks the desired priority, and the information is saved in memory. As shown, priority can be for a period of time, or based on the chat recipient's device being within a predetermined radius of the device 405. Examples shown are 1 mile or 5 miles, but can be any distance. So, the chat recipient would have the selected priority during the time he/she is within the selected radius. It should be recognized that in embodiments, the method of selection of keywords and their priority may be modified, and all such modifications are included within the scope of the invention.

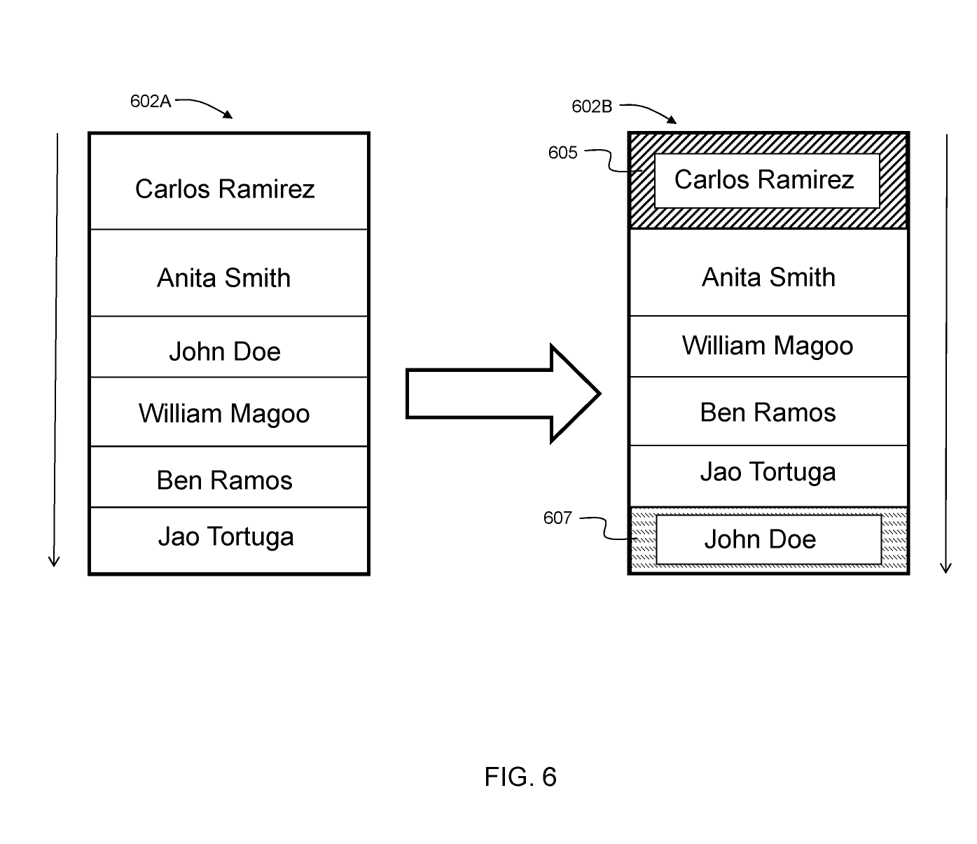

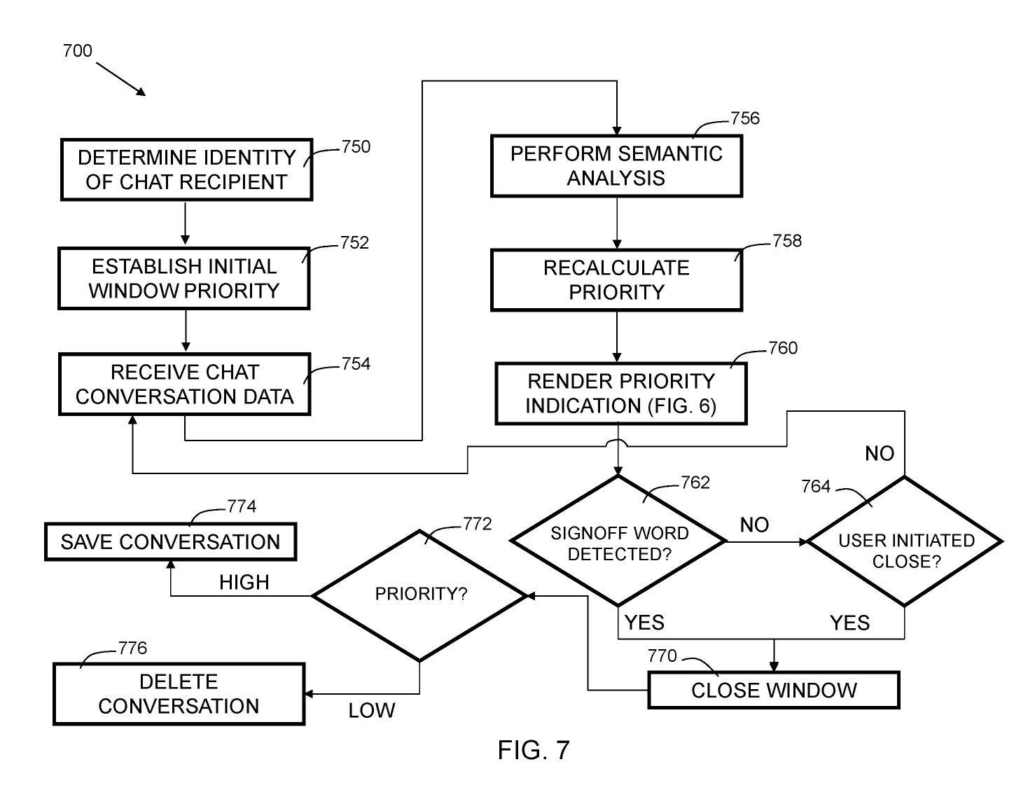

FIG. 6 shows examples of rendering priority indications. The rendering of priority indications may include rendering a graphical display with message representations such as icons or thumbnail images arranged in an order of priority. Other embodiments may include arranging the chat windows in a tiled or layered manner based on the priority. In other embodiments, the rendering of priority indications may include rendering one or more chat windows with borders of different colors based on priority. For example, high priority chat windows can have a red border, represented by border 605, and low priority chat windows can have a yellow border, represented by border 607, as an example. At 602A, Carlos Ramirez is shown having the highest priority with Jao Tortuga having the lowest priority. Anita Smith has second to highest priority followed by John Doe, followed by William Magoo, followed by Ben Ramos. At 602B, there is shown a rendering with the priorities having shifted. Carlos Ramirez is still highest priority followed by Anita Smith, and William Magoo. However, following John C. Doe is now Ben Ramos, Jao Tortuga, and lastly, John Doe.

FIG. 7 is a flowchart 700 indicating process steps for embodiments of the present invention. The identity of a chat recipient is determined at 750. An initial window priority is established at 752. This may be based on identity of the chat recipient. Chat conversation data is sent to and/or received from the chat recipient at 754. Semantic analysis is performed on the chat conversation data at 756. Priority is recalculated based on the semantic analysis at 758. The semantic analysis may include identification of user-defined keywords or geo-location data, etc. A priority indication is rendered for a plurality of chat conversations based on the recalculated/adjusted priority at 760. It is determined whether a signoff word is detected at 762. If no, it is determined whether the user initiated the closing of the chat window at 764, and if no, control is returned to element 754 where the process continues as new chat conversation data continues. Thus, the steps of receiving chat conversation data, performing a semantic analysis on the chat conversation data, and recalculating the chat conversation priority may be repeated during the lifetime of the chat conversation. The lifetime of the chat conversation starts when the chat conversation is initiated, and ends when the chat conversation is closed, either by the user, or automatically by detection of a signoff word. If a signoff word is detected at 762, or window activity is detected at 764, then the chat window is closed at 770. The priority of the conversation is then determined at 772. If high, the conversation is saved at 774. If low, the conversation is deleted at 776.

In embodiments, the chat window priority P_{W}, established at 752 and/or 758, may be computed by the following example formula:

P_{W}=R(P_{R})+C(SUM(K_{X}))

Where R and C are constants, P_{R} is the priority for the recipient, K_{X} represents the priority for keyword x. For each keyword found in a message, the priority of the keywords are summed and then multiplied by constant C. With this formula, a higher value for P_{W} indicates a chat window of greater importance. If P_{W} exceeds a predetermined threshold, then the chat conversation is archived upon closing (at 774). If P_{W} is less than or equal to the threshold, then the chat conversation is deleted upon closing (at 776). Thus, embodiments of the present invention make efficient use of storage by saving important conversations only, and not wasting space on archiving unimportant conversations.

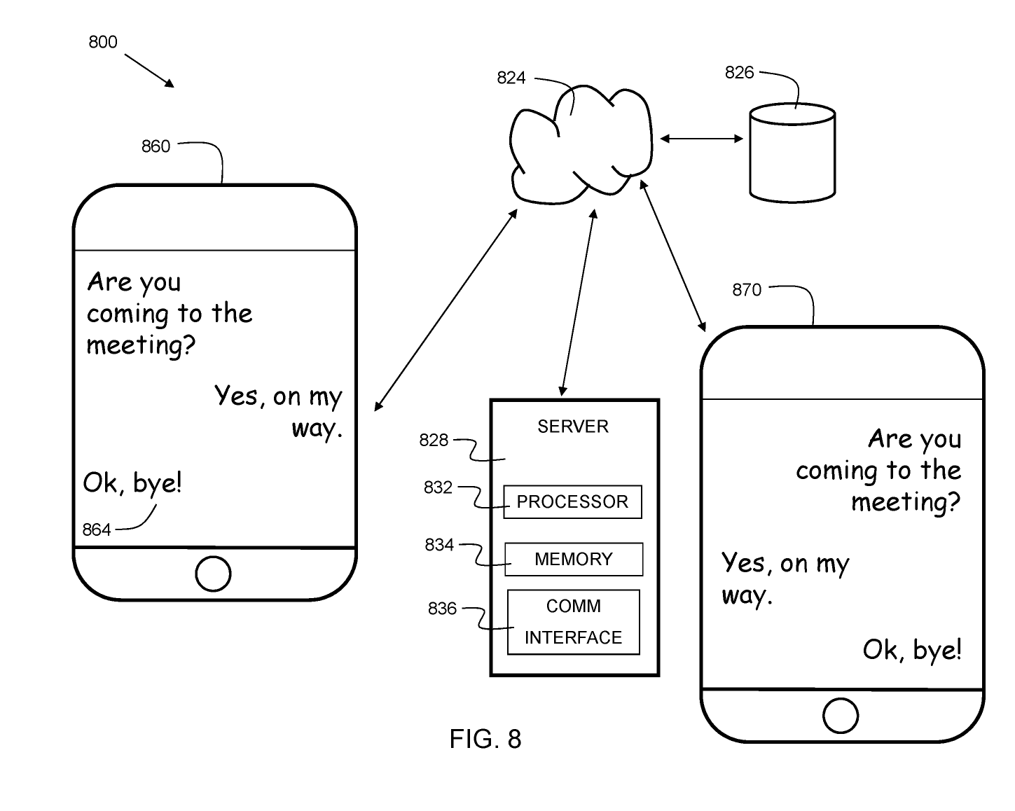

FIG. 8 shows a client-server system 800 in accordance with embodiments of the present invention. A first device 860 is participating in a chat conversation with a second device 870, via network 824. In embodiments, network 824 may include a cellular network, a WiFi network, a Bluetooth™ network, and/or the Internet. A server 828 is also in communication with first device 860 and second device 870. The server 828 comprises a processor 832, a memory 834, and a communication interface 836. The memory contains instructions, that when executed by processor 832, perform one or more functions/tasks to accomplish prioritization of chat conversations. The communication interface 836 facilitates communication of data between other devices via network 824.

In embodiments, the server 828 may receive the chat conversation and analyze it in real time. The server 828 may perform the aforementioned analysis to identify keywords and/or signoff words such as signoff word 864. In embodiments, the server 828 may compute a priority for the chat conversation and transmit the computed priority to device 860 and device 870, so that each device can render the chat conversation accordingly. In some embodiments, the server 828 may send instructions to device 860 and/or 870 to close a chat window in response to detecting a signoff word in conjunction with a predetermined amount of inactivity. The server 828 may issue commands to the device via network 824 to close, highlight, or otherwise arrange a chat window in response to a chat conversation priority that is computed on server 828.

The system 800 may further include a database 826 that is attached to network 824. The database 826 may be used to store keywords and signoff words specified by a plurality of users. In embodiments, a user may create a profile that includes a list of keywords that are pertinent to projects he is working on, as well as signoff words he often uses to signify the end of a chat conversation.

In embodiments, the server 828 may retrieve profile information such as keywords and signoff words from database 826, and use that information to perform the chat conversation priority calculation. Thus, in embodiments, one or more of the modules shown in FIG. 2 may be implemented in server 828. In such embodiments, the server 828 may be performing the chat conversation priority calculation and instructing the corresponding devices 860 and/or 870 to process changes in chat conversation priority. The processing of in chat conversation priority may include, but is not limited to, moving a chat conversation window, closing a chat conversation window, archiving a chat conversation window, and/or rendering the chat conversation window in a different color and/or font to indicate the updated chat conversation priority.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In another embodiment, the invention provides a method that performs the process of the invention on a subscription, advertising, and/or fee basis. That is, a service provider, such as a Solution Integrator, could offer to provide deployment pattern cost analysis functionality. In this case, the service provider can create, maintain, support, etc., a computer infrastructure, such as computer system that performs the processes of the invention for one or more consumers. In return, the service provider can receive payment from the consumer(s) under a subscription and/or fee agreement and/or the service provider can receive payment from the sale of advertising content to one or more third parties.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for prioritizing a chat conversation of a plurality of chat conversations, the method comprising:
determining an identity of a chat recipient of the chat conversation;
establishing an initial chat conversation priority based on the identity of the chat recipient;
receiving chat conversation data from the chat recipient;
performing a semantic analysis on the chat conversation data;
recalculating the chat conversation priority based on the semantic analysis, wherein the steps of receiving chat conversation data, performing a semantic analysis on the chat conversation data, and recalculating the chat conversation priority are repeated during the lifetime of the chat conversation, wherein the semantic analysis includes identification of user-defined keywords; and
rendering a priority indication for the plurality of chat conversations based on the adjusted chat conversation priority.

2. The method of claim 1, further comprising automatically saving the chat conversation if the chat conversation is deemed as a high priority chat conversation.

3. The method of claim 1, further comprising automatically deleting the chat conversation after a user-initiated closing of the chat conversation if the chat conversation is deemed as a low priority chat conversation.

4. The method of claim 1, wherein the semantic analysis further includes detection of a signoff phrase within the chat conversation data.

5. The method of claim 4, further comprising closing the chat conversation after a predetermined duration from detection of the signoff phrase.

6. The method of claim 5, further comprising closing the chat conversation after a predetermined duration of inactivity.

7. The method of claim 1, further comprising;
establishing a list of chat contacts; and
establishing an initial chat conversation priority for each chat contact in the list of chat contacts.

8. The method of claim 7, further comprising;
establishing a list of keywords; and
establishing a priority for each keyword in the list of keywords.

9. The method of claim 1, further comprising recalculating the chat conversation priority based on geolocation information from the chat recipient.

10. A device comprising:
a processor;
a memory coupled to the processor;
an electronic display coupled to the processor;
wherein the memory contains instructions, which when executed by the processor, perform the steps of:
determining an identity of a chat recipient of the chat conversation;
establishing an initial chat conversation priority based on the identity of the chat recipient;
receiving chat conversation data from the chat recipient;
performing a semantic analysis on the chat conversation data;
recalculating the chat conversation priority based on the semantic analysis, wherein the semantic analysis includes identification of user-defined keywords; and
rendering on the electronic display, a priority indication for the plurality of chat conversations based on the adjusted chat conversation priority.

11. The device of claim 10, wherein the memory further contains instructions, which when executed by the processor, perform the step of automatically saving the chat conversation if the chat conversation is deemed as a high priority chat conversation.

12. The device of claim 10, wherein the memory further contains instructions, which when executed by the processor, perform the step of automatically deleting the chat conversation after a user-initiated closing of the chat conversation if the chat conversation is deemed as a low priority chat conversation.

13. The device of claim 10, wherein the memory further contains instructions, which when executed by the processor, perform the step of detecting a signoff phrase within the chat conversation data.

14. The device of claim 13, wherein the memory further contains instructions, which when executed by the processor, perform the step of closing the chat conversation after a predetermined duration from detection of the signoff phrase.

15. The device of claim 14, wherein the memory further contains instructions, which when executed by the processor, perform the step of closing the chat conversation after a predetermined duration of inactivity.

16. A computer program product for prioritizing a chat conversation on an electronic device, comprising a computer readable storage medium having program instructions embodied therewith, the program instructions executable by a processor to cause the electronic device to:
render an identity of a chat recipient of the chat conversation;
establish an initial chat conversation priority based on the identity of the chat recipient;
obtain chat conversation data from the chat recipient;
perform a semantic analysis on the chat conversation data;
recalculate the chat conversation priority based on the semantic analysis, wherein the semantic analysis includes identification of user-defined keywords; and
render a priority indication for the plurality of chat conversations based on the adjusted chat conversation priority.

17. The computer program product of claim 16, wherein the computer readable storage medium further includes instructions executable by the processor to cause the electronic device to save the chat conversation if the chat conversation is deemed as a high priority chat conversation.

18. The computer program product of claim 16, wherein the computer readable storage medium further includes instructions executable by the processor to cause the electronic device to delete the chat conversation after a user-initiated closing of the chat conversation if the chat conversation is deemed as a low priority chat conversation.

19. The computer program product of claim 16, wherein the computer readable storage medium further includes instructions executable by the processor to cause the electronic device to detect a signoff phrase within the chat conversation data.

20. The computer program product of claim 19, wherein the computer readable storage medium further includes instructions executable by the processor to cause the electronic device to close the chat conversation after a predetermined duration from detection of the signoff phrase.
